(19) United States
(12) Patent Application Publication
(10) Pub. No.: US 2023/0001603 A1
(43) Pub. Date: Jan. 5, 2023

(54) A RIM -TYPE ABRASION CUTTER DRIVE SPROCKET, A DRIVE ARRANGEMENT, AN ABRASION CUTTER AND A METHOD OF DRIVING AN ABRASION CUTTING CHAIN OF AN ABRASION CUTTER

(71) Applicant: HUSQVARNA AB, Huskvarna (SE)

(72) Inventors: Per Söderlind, Jönköping (SE); Per Orestig, Bankeryd (SE)

(21) Appl. No.: 17/780,212

(22) PCT Filed: Nov. 5, 2021
(86) PCT No.: PCT/SE2020/051061

§ 371 Date: May 26, 2022

(30) Foreign Application Priority Data
Nov. 27, 2019 (SE) 1951356-3

(51) Int. Cl. B27B 17/08; F16H 7/06

(52) U.S. Cl. CPC B27B 17/08; F16H 7/06

(57) ABSTRACT

A rim-type abrasion cutter drive sprocket (24) for driving an abrasion cutting chain (16) of an abrasion cutter (10) comprises a set of sprocket teeth, which extend radially away from the drive sprocket's rotation axis (A), and define drive link gaps between them for receiving and drivingly engaging with drive links (26) of the cutting chain (16), and a pair of rim edges (44) which are concentric with and extend about the rotation axis (A) on either side of the drive link gaps, the rim edges (44) being configured to radially support side links (28) of the cutting chain (16). The rim edges (44) have a non-circular envelope, as seen along the rotation axis (A).

### FIELD OF THE INVENTION

The present invention relates to a rim-type abrasion cutter drive sprocket, and to a method of driving an abrasion cutting chain.

### BACKGROUND

Abrasion cutting is based on abrasive removal of material to form a kerf in an object being cut. Handheld power tools and cutting chains for abrasion cutting of minerals, such as rock, concrete or the like, are known in the art. U.S. Pat. No. 8,960,178 B2 discloses an exemplary cutting chain consisting of drive links and side links alternatingly arranged along the length of the chain. The drive links are configured to be driven by a rim-type sprocket, whereas a subset of the side links are provided with abrasion cutting teeth.

Due to the highly abrasive environment of concrete cutting, the cutting equipment is exposed to substantial wear, and regularly needs to be replaced.

### SUMMARY

It is an object of the present invention to solve, or at least mitigate, parts or all of the above mentioned problems. To this end, there is provided a rim-type abrasion cutter drive sprocket for driving an abrasion cutting chain of an abrasion cutter, the rim-type sprocket being configured to be rotated about a rotation axis for driving the cutting chain, and comprising a set of sprocket teeth, the sprocket teeth extending radially away from said rotation axis and defining drive link gaps between them for receiving and drivingly engaging with drive links of the cutting chain, and a pair of rim edges which are concentric with the rotation axis and extend about the rotation axis on either side of the drive link gaps, the rim edges being configured to radially support side links of the cutting chain, wherein the rim edges have a non-circular envelope, as seen along the rotation axis. Thereby, a driving force may be transferred also from the rim edges to the side links, which reduces the stretching of the cutting chain at the interfaces between drive links and side links. This enables obtaining an increased lifetime of the sprocket as well as the cutting chain. There is also provided an abrasion cutter provided with a rim-type drive sprocket as defined herein. Typically, the abrasion cutter is powered by a motor, such as a combustion engine, in driving engagement with the rim-type drive sprocket to move the abrasion cutting chain. The abrasion cutter may be handheld, i.e. it may be a handheld power tool. Alternatively, the abrasion cutter may be mounted on a cutting rig for autonomous or remote-controlled operation.

According to embodiments, each of said rim edges may have a rim edge radius which varies along the circumference of the respective rim edge between a smallest rim edge radius and a largest rim edge radius, wherein a ratio between the smallest rim edge radius and the largest rim edge radius is between 0.82 and 0.96. According to further embodiments, a ratio between the smallest rim edge radius and the largest rim edge radius may be between 0.85 and 0.93.

According to embodiments, each of said rim edges may have a rim edge radius which varies along the circumference of the respective rim edge, wherein each respective rim edge has a first, relatively smaller, radius at the sprocket teeth, and a second, relatively larger, radius at the drive link gaps. Relatively larger and relatively smaller should be construed as being in relation to each other, i.e. relatively larger is larger than relatively smaller.

According to embodiments, said non-circular envelope may be substantially polygonal. A polygon comprises straight sides interconnected by corners. The corners of the substantially polygonal envelope may be chamfered or rounded, to minimize wear on the cutting chain.

According to embodiments, the substantially polygonal envelope may have the shape of a regular polygon. Again, the corners of the regular polygon-shaped envelope may be chamfered or rounded, to minimize wear on the cutting chain. The regular polygon may have a number of sides which matches the number of sprocket teeth of said set of sprocket teeth.

According to embodiments, corners of the substantially polygonal envelope may be in register with the drive link gaps, as seen along the rotation axis. With such a configuration, according to tests, the service life of the sprocket is about twice that of a conventional abrasion cutter drive sprocket having circular rim edges.

According to embodiments, radial ends of the sprocket teeth may be substantially aligned with mid-points of respective sides of the polygonal envelope. The rotation axis defines a circular-cylindrical coordinate system, defining an axial direction, a radial direction, and a tangential or angular direction, which directions are referred to herein. The radial ends of the sprocket teeth may be radially aligned with said mid-points, tangentially aligned with said mid-points, or both. The sprocket teeth may thereby be tangentially distributed in anti-phase with the corners of the substantially polygonal envelope.

According to embodiments, the substantially polygonal envelope is hexagonal, heptagonal, or octagonal.

According to embodiments, the sprocket may be provided with internal splines configured to engage with mating external splines of a drive shaft. Thereby, the sprocket may be allowed to float axially on the shaft, which reduces wear of the sprocket as well as the cutting chain. The internal splines of the sprocket may be configured as axially extending grooves in an otherwise circular-cylindrical socket.

According to embodiments, the sprocket may be integrally formed in a single piece. By way of example, the sprocket may be sintered or moulded in a single piece, or welded from two or more components into a single piece. Typically, the sprocket may be made of metal, such as steel.

According to a second aspect, parts or all of the above mentioned problems are solved, or at least mitigated, by a kit comprising a drive sprocket as defined hereinabove, and an abrasion cutting chain provided with abrasion cutting teeth configured to cut minerals such as concrete or rock, and/or metals such as cast iron or the like, by abrasive action. Due to their abrasive cutting action, the cutting teeth typically do not have any sharp cutting edges configured to shave off chips, as opposed to e.g. a cutting chain adapted for cutting wood, and therefore also do not need sharpening. The abrasion cutting teeth may, for example, be configured as sintered or moulded steel bodies with embedded abrasive particles having a Mohs hardness exceeding 9, such as silicon carbide, tungsten carbide, or diamond particles. The abrasion cutting teeth may be attached to side links of the cutting chain. The cutting chain may comprise a plurality of side links, each provided with a straight riding edge configured to ride on an outer periphery of a guide bar.

According to embodiments, the kit may further comprise a guide bar for guiding the cutting chain, the guide bar comprising coolant channels for delivering a coolant flow to a guide groove configured to receive and guide drive teeth of the cutting chain.

According to an embodiment, there is also provided an abrasion cutter comprising a rim-type drive sprocket or kit as defined above.

According to a third aspect, parts or all of the above mentioned problems are solved, or at least mitigated, by a method of driving an abrasion cutting chain of an abrasion cutter, the method comprising rotating a sprocket about a rotation axis; transferring rotary power from sprocket teeth to drive links of the cutting chain; and transferring rotary power from at least one sprocket rim, offset from the sprocket teeth along the rotation axis, to side links of the cutting chain, by interference between the at least one sprocket rim and the side links. Thanks to the interference engagement between the sprocket rim and the side links, more power can be transferred than via only a mere friction engagement between the two. This reduces the load and wear on the interfaces between the side links and the drive links of chain.

According to embodiments, said interference may transfer rotary power from substantially straight drive edges of the rim to substantially straight riding edges of the side links, as seen along the axis of rotation.

According to embodiments, the drive edges and riding edges may engage with each other along a straight engagement line which extends in opposite tangential directions from a point of the engagement line which is closest to the rotation axis.

It is noted that embodiments of the invention may be embodied by all possible combinations of features recited in the claims. Further, it will be appreciated that the various embodiments described for the devices according to the first and second aspects are all combinable with the method as defined in accordance with the third aspect, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a view in perspective of a handheld abrasion cutter;

FIG. 2 is a side view of a rim-type drive sprocket, a drive shaft, a proximal end of a guide bar, and an abrasion cutting chain;

FIG. 3 is a side view of the abrasion cutting chain of FIG. 2;

FIG. 4 is a perspective view of the drive sprocket and drive shaft of FIG. 2;

FIG. 5 is a section view of the drive sprocket of FIG. 2 in mesh with a set of drive teeth of the cutting chain of FIG. 3, the section being taken in a plane comprising the drive teeth; and

FIG. 6 is a flow chart illustrating a method of driving the abrasion cutting chain of FIG. 3.

All the figures are schematic, not necessarily to scale, and generally only show parts which are necessary in order to elucidate the embodiments, whereas other parts may be omitted.

### DETAILED DESCRIPTION OF THE EXEMPLARY EMBODIMENTS

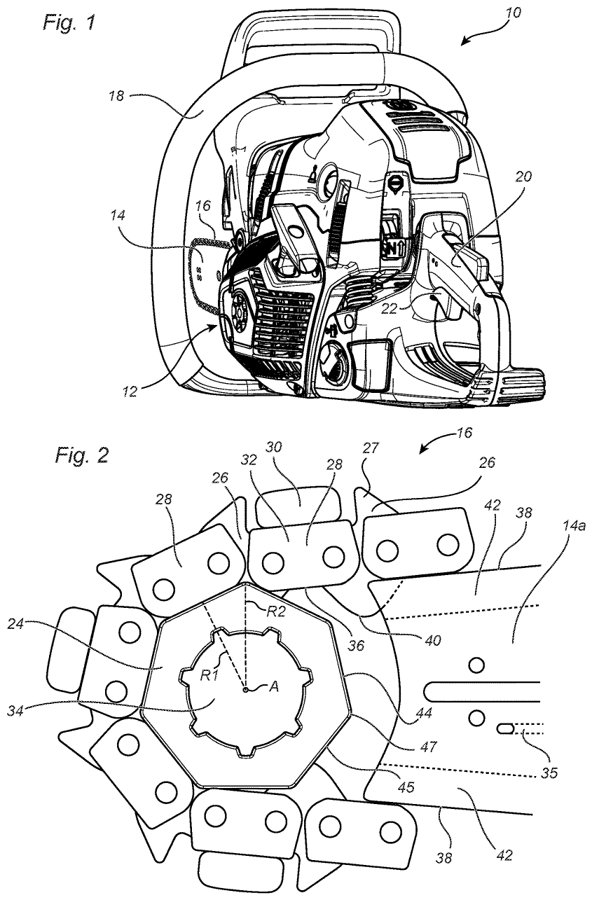

FIG. 1 illustrates a handheld abrasion cutter, i.e. a handheld power cutter 10 configured to cut metal, mineral such as rock or concrete, or the like by abrasive action. The power cutter comprises a power unit 12, which comprises a motor such as an internal combustion engine (not visible), and a guide bar 14 extending from the power unit 12. An abrasion cutting chain 16 is guided along the guide bar 14. The cutting chain 16 is configured as an endless loop which is moved along the periphery of the guide bar 14 by the motor of the power unit 12. A front handle 18 and a rear 20 handle permit holding the power cutter 10 with two hands, and the rear handle 20 is provided with a trigger 22 for operating the motor (not illustrated).

FIG. 2 illustrates the cutting chain 16, a drive sprocket 24 of rim type, and a proximal end 14a of the guide bar 14 (FIG. 1) in greater detail. The cutting chain 16 comprises drive links 26 interconnected by side links 28. The side links 28, which may alternatively be referred to as tie straps, are arranged in pairs, each pair of side links 28 sandwiching two consecutive drive links 26 between them. A subset of the side links 28 are provided with abrasion cutting teeth 30 comprising embedded diamond particles (not illustrated), and are thereby well suited for cutting concrete, rock, or the like, by abrasive action. The subset of side links 28 provided with cutting teeth 30 may also be referred to as cutting links 32. The motor of the power unit 12 (FIG. 1) is drivingly connected to a drive shaft 34, which drivingly engages with the drive sprocket 24 to rotate the drive sprocket 24 about a rotation axis A, concentric with the drive shaft 34 and drive sprocket 24, and perpendicular to the general plane of extension of the drive sprocket 24.

Each side link 28 has a straight riding edge 36 configured to ride on an outer periphery 38 of the guide bar 14 (FIG. 1). The drive links 26 are provided with respective drive teeth 40, which are guided in a guide groove 42 in the periphery 38 of the guide bar 14 (FIG. 1); in the view of FIG. 2, the bottom of the guide groove 42 is indicated by a dotted line. The guide bar 14, the proximal end 14a of which is illustrated in FIG. 2, comprises a coolant channel arrangement 35 for delivering a flow of coolant such as water from the power unit 12 (FIG. 1) to the guide groove 42. The drive teeth 40 penetrate into the drive sprocket 24 to engage with sprocket teeth (not illustrated) in a manner which will be elucidated further below, whereas the side links 28 are radially supported by outer rim edges 44 of the drive sprocket 24. The drive sprocket 24 is integrally moulded in one piece of steel. Its rim edges 44 define an envelope, as seen along the rotation axis A, the shape of a regular polygon, and more specifically, of a heptagon. The heptagon has seven sides 45 of equal length, wherein adjacent sides meet each other at corners 47 of equal angles.

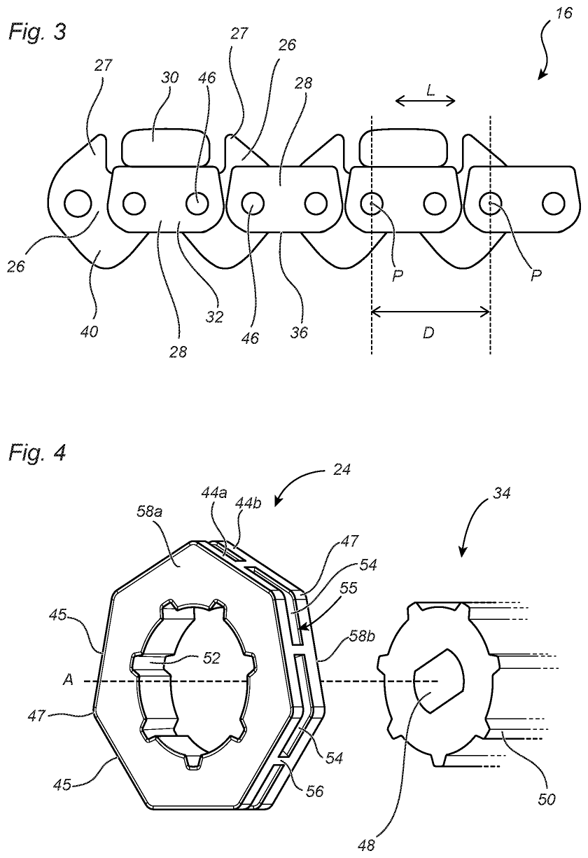

FIG. 3 illustrates a few segments of the cutting chain 16 in greater detail. Each drive link 26 is, at each longitudinal end as seen along the longitudinal direction L of the cutting chain, pivotally connected to a pair of side links 28 via rivets 46. The side links 28 are located on opposite sides of the plane of the drive link 26 such that in the view of FIG. 3, only one side link 28 of each such pair is visible. The drive links 26 are provided with bumpers 27, which protect the cutting teeth 30 from excessive impact. The pitch of the cutting chain 16 is defined as half the distance D between the leading rivet pivot axes P of two consecutive drive links 26; a typical pitch may be, for example, between 8.0 mm and 11.5 mm. Common pitches are ⅜-inch and 0,444-inch pitches.

FIG. 4 illustrates the sprocket 24 and an axial end of the drive shaft 34 in greater detail. The drive shaft 34 may, in turn, be configured as a sleeve enclosing a smaller drive dog 48. The drive shaft 34 is provided with external splines 50, mating with internal splines 52 of the drive sprocket 24. The drive sprocket 24 comprises drive link gaps 54 defining, along the radial periphery of the drive sprocket 24, slots 55, which are adapted to receive the drive teeth 40 of the drive links 26 (FIG. 3). The slots 55 are located at the polygon corners 47 of the drive sprocket's 24 polygonal envelope, and are separated by sprocket teeth 56, which are located at the centres of the respective sides 45 of the polygonal envelope. The axial sides of the of the drive sprocket 24 are axially offset from the drive links 26, and define opposing rims 58a, 58b. The radially outermost, polygonal, envelope of the rims 58a, 58b of the rim-type drive sprocket 24 form a pair of rim edges 44a, 44b, which are configured to radially support the side links 28 (FIG. 2) of the cutting chain 16 (FIG. 1). Referring back to FIG. 2, each rim edge 44a, 44b extends at a varying radial distance from the rotation axis A, i.e. it has a rim edge radius which varies along the circumference of the respective rim edge 44a, 44b. The radius of each rim edge 44a, 44b varies between a smallest rim edge radius R1, at the tangential positions of the sprocket teeth 56, and a largest rim edge radius R2, at the tangential positions of the drive link gaps 54. For the illustrated sprocket 24, the ratio between the smallest rim edge radius R1 and the largest rim edge radius R2 is about 0.9.

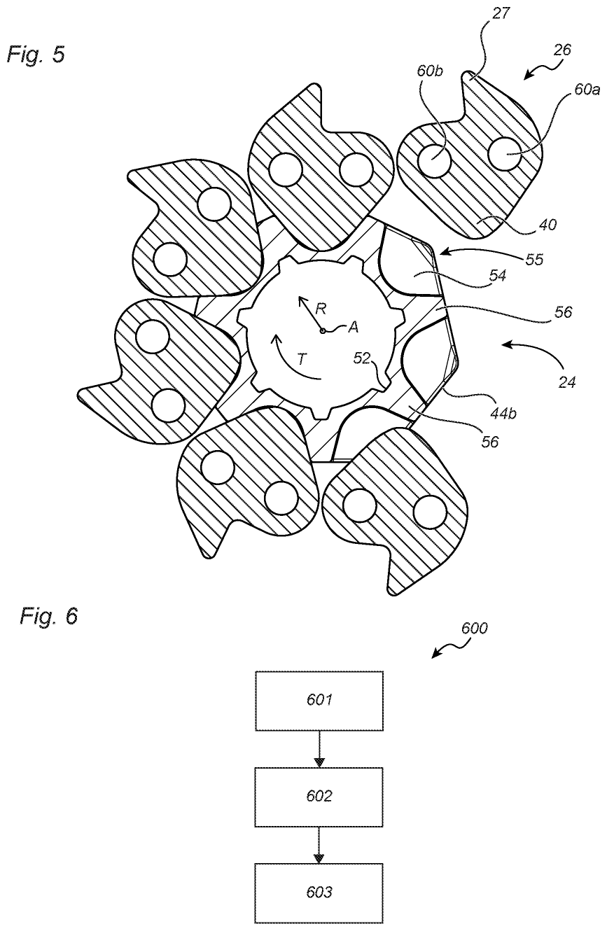

FIG. 5 illustrates the sprocket 24 and the drive links 26 of the cutting chain 16 (FIG. 1) in a section taken along the plane of the drive links 26, perpendicular to the rotation axis A. Each drive link 26 comprises a leading rivet bore 60a and a trailing rivet bore 60b, each of which is connected to a pair of parallel tie straps 28 (FIG. 3) by rivets 46. The rotation axis A of the sprocket 24 defines a cylindrical coordinate system of the drive sprocket 24, with a radial direction R facing perpendicularly away from the rotation axis A, and an angular or tangential direction T corresponding to the movement direction of any point rotating about the axis A. The drive link gaps 54 are shaped to mate with the drive links 26, with some added tangential play towards the bottom of the gaps 54, to provide a high mechanical strength of the drive sprocket 24, while at the same time allowing some degree of pivoting of the drive links about the rivets (FIG. 3) within the respective drive link gaps 54. The pitch of the sprocket 24 is carefully matched to the pitch of the cutting chain (FIG. 3), such that all drive links 26 will, when passing the drive sprocket 24, engage with and be driven by a respective sprocket tooth 56 of the drive sprocket 24. The sprocket teeth 56 extend radially all the way out to the rim edges 44a, 44b (FIG. 4), i.e. in the illustrated embodiment, all the way out to the respective sides 45 of the polygonal envelope. This means that the sprocket teeth 56 do not extend beyond the rim edges 44a, 44b, and thus the sprocket teeth 56 extend radially away from said rotation axis A at most until the rim edges 44a, 44b. This provides an advantage regarding manufacturing, where for example moulding is simplified. It is also ensured that the sprocket teeth 56 do not interfere with other parts of the cutting chain 16 than intended.

Now referring back to FIG. 2, the substantially straight drive edges formed by the rim edges 44a, 44b extending along the sides 45 of the sprocket's polygonal envelope engage with the respective riding edges 36 along straight engagement lines. Each straight engagement line extends in opposite tangential directions from the centre of the respective polygon side 45, i.e. from the radial end of the respective sprocket tooth 56. This is also where the engagement line is the closest to the rotation axis A.

The flow chart of FIG. 6 illustrates a method 600 of driving an abrasion cutting chain of a handheld abrasion cutter, such as the cutting chain 16 illustrated with reference to FIGS. 1-5. The method makes use of a rim-type sprocket such as that described with reference to FIGS. 1-5, and is for clarity of illustration described with reference to those figures. The method comprises

601: rotating the sprocket 24 about the rotation axis A,

602: transferring rotary power from the sprocket teeth 56 to the drive links 26 of the cutting chain 16, and

603: transferring rotary power from the sprocket rims 58a, 58b to the side links 28 of the cutting chain 16, by interference between the sprocket rims 58a, 58b and the side links 28.

The method may be used when cutting mineral or metal by abrasive action.

By having a not only purely tangential line of engagement between the sprocket rims 58a, 58b and the side links 28, more power can be transferred than via only a mere friction engagement between the two. In the example described in detail above, the straight side edges defined by the polygonal envelope of the rim edges 44a, 44b transfer the rotary power to the straight riding edges 36 of the side links 28.

The invention has mainly been described above with reference to a few embodiments. However, as is readily appreciated by a person skilled in the art, other embodiments than the ones disclosed above are equally possible within the scope of the invention, as defined by the appended patent claims. For example, it is not necessary that the rim edges be polygonal. Also other shapes which are non-circular, such as sawtooth or star shapes, may be suitable for transferring rotary power to the side links of the cutting chain. It may be preferable that the cutting chain, in such configurations, be provided with mating drive structures at the riding edges 36 of the side links 28. This means that the rim edges 44a, 44b and the riding edges 36 have complementary shapes that are adapted to mate with each other such that the riding edges 36 can engage the rim edges 44a, 44b. In this way, the cutting chain 16 is propelled both by means of transferred rotary power from sprocket teeth 56 to drive links 26 of the cutting chain 16, and by transferred rotary power from the rim edges 44a, 44b to the riding edges 36. At least one sprocket rim 58a, 58b, offset from the sprocket teeth 56 along the rotation axis A is thus adapted to transfer rotary power to side links 28 of the cutting chain 16 by interference between the at least one sprocket rim 58a, 58b and the side links 28.

The complementary shapes are of such form that at least 50% of the riding edges 36 are adapted to be in contact with the rim edges 44a, 44b, preferably at least 75%, and most preferably at least 90%.

According to some aspects, in order to enable this power transfer, drive teeth 40 of the drive links 26 should not engage the drive link gaps 54 to such an extent that the riding edges 36 do not completely engage the rim edges 44a, 44b. For example, if the drive teeth 40 ride on the bottom of the drive link gaps 54, the riding edges 36 may not be enabled to reach the rim edges 44a, 44b to the desired extent.

By having the driving force transferred not only from the sprocket teeth 56 to the drive links 26, but also also from the rim edges 44a, 44b to the riding edges 36 of the side links, the stretching of the cutting chain at the interfaces between drive links and side links is reduced. This enables obtaining an increased lifetime of the sprocket as well as the cutting chain.

It is also pointed out that abrasion cutting is also suitable for cutting other materials, such as plastics, and the teachings herein are in no way limited to the cutting of a particular type of material.

In the claims, the word “comprising” does not exclude other elements or steps, and the indefinite article “a” or “an” does not exclude a plurality.

1. A rim-type abrasion cutter drive sprocket for driving an abrasion cutting chain of an abrasion cutter, the rim-type sprocket being configured to be rotated about a rotation axis for driving the cutting chain, and comprising:
a set of sprocket teeth, the sprocket teeth extending radially away from said rotation axis and defining drive link gaps between the sprocket teeth for receiving and drivingly engaging with drive links of the cutting chain, and
a pair of rim edges which are concentric with the rotation axis and extend about the rotation axis on either side of the drive link gaps, the rim edges being configured to radially support side links of the cutting chain,
wherein the rim edges have a non-circular envelope, as seen along the rotation axis, and
wherein the sprocket teeth extend radially away from said rotation axis at most until the rim edges.

2. The drive sprocket according to claim 1, wherein each of said rim edges has a rim edge radius which varies along a circumference of the respective rim edge between a smallest rim edge radius and a largest rim edge radius, wherein a ratio between the smallest rim edge radius and the largest rim edge radius is between 0.82 and 0.96.

3. The drive sprocket according to claim 1, wherein each of said rim edges has a rim edge radius which varies along a circumference of the respective rim edge, wherein each respective rim edge has a first, relatively smaller, radius at the sprocket teeth, and a second, relatively larger, radius at the drive link gaps.

4. The drive sprocket according to claim 1, wherein said non-circular envelope is substantially polygonal.

5. The drive sprocket according to claim 4, wherein the substantially polygonal envelope has the shape of a regular polygon.

6. The drive sprocket according to claim 5, wherein the regular polygon has a number of sides which matches a number of sprocket teeth of said set of sprocket teeth.

7. The drive sprocket according to claim 4, wherein corners of the substantially polygonal envelope are in register with the drive link gaps, as seen along the rotation axis.

8. The drive sprocket according to claim 4, wherein radial ends of the sprocket teeth are substantially aligned with mid-points of respective sides of the polygonal envelope.

9. The drive sprocket according to claim 4, wherein the substantially polygonal shape is hexagonal, heptagonal, or octagonal

10. The drive sprocket according to claim 1, wherein the drive sprocket is provided with internal splines configured to engage with mating external splines of a drive shaft.

11. The drive sprocket according to claim 1, wherein the drive sprocket is integrally formed in a single piece or is moulded in a single piece.

12. (canceled)

13. A rim-type abrasion cutter drive arrangement comprising a drive sprocket according to claim 1, and an abrasion cutting chain provided with abrasion cutting teeth configured to cut concrete, rock, or the like, by abrasive action where the abrasion cutting chain comprises drive links interconnected by side links, each side link having a riding edge with a drive structure that is adapted to mate with the rim edges of the drive sprocket, enabling the rim edges to transfer the rotary power to the riding edges of the side links.

14. The drive arrangement according to claim 13, wherein at least 50% of each riding edge is adapted to engage a corresponding rim edge.

15. The drive arrangement according to claim 14, wherein each riding edge is straight and adapted to engage a corresponding straight rim edge.

16. The drive arrangement according to claim 13, further comprising a guide bar for guiding the cutting chain, the guide bar comprising coolant channels for delivering a coolant flow to a guide groove configured to receive and guide drive teeth of the cutting chain.

17. An abrasion cutter comprising a drive sprocket according to claim 1 and an abrasion cutting chain provided with abrasion cutting teeth configured to cut concrete, rock, or the like, by abrasive action, wherein the abrasion cutting chain comprises drive links interconnected by side links, each side link having a riding edge with a drive structure that is adapted to mate with the rim edges of the drive sprocket, enabling the rim edges to transfer the rotary power to the riding edges of the side links.

18. (canceled)

19. The abrasion cutter according to claim 16, wherein each riding edge is straight and adapted to engage a corresponding straight rim edge.

20. A method of driving an abrasion cutting chain of an abrasion cutter, the method comprising
rotating a sprocket about a rotation axis;
transferring rotary power from sprocket teeth to drive links of the cutting chain; and
transferring rotary power from at least one sprocket rim, offset from the sprocket teeth along the rotation axis, to side links of the cutting chain, by interference between the at least one sprocket rim and the side links where said interference transfers rotary power from drive edges of said at least one sprocket rim to riding edges of the side links, each riding edge having a drive structure that is adapted to mate with rim edges of the drive sprocket, enabling the rim edges to transfer the rotary power to the riding edges of the side links.

21. The method according to claim 20, wherein said interference transfers rotary power from substantially straight drive edges of the at least one sprocket rim to substantially straight riding edges of the side links, as seen along the rotation axis.

22. The method according to claim 21, wherein the drive edges and riding edges engage with each other along a straight engagement line which extends in opposite tangential directions from a point of the engagement line which is closest to the rotation axis.
